(19) United States
(12) Patent Application Publication
(10) Pub. No.: US 2014/0259914 A1
(43) Pub. Date: Sep. 18, 2014

(54) HOLLOW POT

(71) Applicant: Chin Tai TSAI, Taichung City (TW)

(72) Inventor: Chin Tai TSAI, Taichung City (TW)

(21) Appl. No.: 13/802,228

(22) Filed: Mar. 13, 2013

(51) Int. Cl. A01G 9/02

(52) U.S. Cl. CPC A01G 9/02; A01G 9/021
USPC 47/65.7; 47/65.5; 47/79

(57) ABSTRACT

A hollow pot includes a pot unit and a hollow tube. The hollow tube is a hollow unit and installed to inner surface of a mold set before pressurized air is introduced in the mold set and before the mold set is closed. A probe is inserted into the mold set and blows the plastic material in the mold set. The plastic material expands and contacts against the inner surface of the mold set, and seals the connection holes of the hollow tube. The plastic material is extended and broken to match upon the connection holes of the hollow tube. The plastic material is solidified to form the pot unit. The pot unit is air-tightly connected to the hollow tube, and the conjunction area of the hollow tube communicates with the space in the pot unit.

The present invention is a Continuation-In-Part application of applicant's former application with application Ser. No. 13/168,021 filed on Jun. 24, 2011.

### FIELD OF THE INVENTION

### Background of the Invention

A conventional pot for plant generally is made by pottery clay, porcelain or plastic, and includes a single layer with the inside and the outside. A hole is defined in the bottom of the pot which has an open top so that soil is put in the pot via the open top. The plant is planted in the soil.

However, people in the modern world are busy and may not able to regularly water the plant and some people thought that the more water to the plant, the healthier the plant will be so that more than needed water is poured to the pot and the water that cannot be absorbed by the soil leaks from the hole in the bottom of the pot. The water and the soil that leak from the hole of the pot directly drop to the floor and form dark spots which are difficult to clean up. If the pot is located at a higher position, the leakage may generate noise. In the daytime, the temperature in the pot increases so that the humidity and temperature are trapped in the soil so that the roots of the plant are easily decayed. Besides, if the owner leaves for couple of days, the plant will be dead because no water is supplied.

The present invention intends to provide a hollow pot for plant and has a space defined between inner and outer layers of the pot, and water is stored in the space so as to adjust temperature and humidity in the soil efficiently. In consequence, the hollow pot will be able to solve these problems and benefit to more manufacturers and consumers.

### SUMMARY OF THE INVENTION

The present invention relates to a hollow pot which comprises a pot unit and a hollow tube. The hollow tube is installed to inner surface of a mold set before pressurized air is introduced in the mold set and before the mold set is closed. A probe is inserted into the mold set and blows the plastic material in the mold set. The plastic material expands and contacts against the inner surface of the mold set, and seals the connection holes of the hollow tube. The plastic material located outside of the connection holes is forced and pushed into the connection holes due to pressure difference by continuously introducing air into the mold set. The plastic material is extended and broken to match upon the connection holes of the hollow tube. The plastic material is solidified to form the pot unit with the hollow tube located therein. The pot unit is air-tightly connected to the hollow tube, and the conjunction area of the hollow tube communicates with the space in the pot unit. The hollow pot is made by two different materials which are connected to each other by way of air blow molding. There will be not necessary to drill after the pot is made and no extra machining is needed. Furthermore, the liquid in the space of the pot moves upward via the path due to siphon effect so that the soil in the reception area absorbs the water. The pressure of inside the space is lower than the atmosphere so that the pressure is supplied into the space via the path to let the water in the space to move upward to automatically water the soil. Therefore, the soil of the pot is always supplied by small amount of water and the humidity of the soil is proper for the roots of the plant. The special arrangement allows the owners of the plant to travel for a period of days while the soil is supplied sufficient water.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the exploded view of the pot of the present invention;

FIG. 2 shows that water is introduced into the space of the pot of the present invention;

FIG. 3 shows that a plant is planted in the soil in the pot;

FIG. 4 shows that the level of the water in the pot is lowered;

FIG. 5 shows that the level of the water in the pot is further lowered;

FIG. 6 shows a second embodiment of the pot of the present invention;

FIG. 7 shows that a plant is planted in the soil in the pot as shown in FIG. 6;

FIG. 8 shows a third embodiment of the pot wherein a plant is planted in the soil in the pot, and

FIG. 9 shows a fourth embodiment of the pot wherein a plant is planted in the soil in the pot.

### DETAILED DESCRIPTION OF THE PREFERRED EMBODIMENT

Referring to FIGS. 1 to 9, the hollow pot of the present invention comprises a pot unit 1 which has an inner layer 10 with a recessed reception area 13 defined therein, an outer layer 11 supporting the inner layer 10, and a space 12 located between the inner and outer layers 10, 11. A through hole 133 is located in communication between the reception area 13 and the space 12. A water introducing unit 3 is located in communication between the space 12 and outside of the pot unit 1. A seal unit 6 seals the water introducing unit 3, and a path A communicates between the space 12 and the outside of the pot unit 1. The reception area 13 of the inner layer 10 has a recessed area 131 and at least one through hole 133 is defined in the recessed area 131. The through hole 133 communicates with the space 12. The through hole 133 is integrally formed simultaneously with the formation of the pot unit 1, or the through hole 133 is formed by drilling action after the pot unit 1 is formed.

The inner layer 10 of the space 12 is air-tightly in contact with the outer layer 11. The seal unit 6 seals the water introducing unit 3 so as to form an enclosed area in the space 12 in the pot unit 1. As shown in FIGS. 1 to 8, the inner and outer layers 10, 11 are integrally formed by air blow molding, or as shown in FIG. 9, the inner and outer layers 10, 11 are two individual layers and are connected to each other, and a seal member 17 is located between the inner and outer layers 10, 11 to ensure that the space 12 is an enclosed space.

The enclosed area in the space 12 is defined between the water introducing unit 3 sealed by the seal unit 6 and an inlet 14 (where the space 12 communicates with the second connection hole 21 of the hollow tube 2). Alternatively, the enclosed area in the space 12 is defined between the through hole 133 and the water introducing unit 3 sealed by the seal unit 6. Alternatively, enclosed area in the space 12 is defined between the contact area between the hollow tube 2 and the pot unit 1, and the water introducing unit 3 sealed by the seal unit 6.

The path A is made by way of drilling the pot unit 1 after the pot unit 1 is completed by way of air blow molding, or by way of drilling the pot unit 1 after the pot unit 1 is completed with the hollow tube 2 is formed therein, or by way of forming the hollow tube 2 in the pot unit 1 by way of air blow molding, or by way of directly forming the hollow tube 2 in the pot unit 1 by way of plastic injection molding. The path A means that the hollow tube 2 which is in communication between the space 12 and the outside of the pot unit 1. The hollow tube 2 has a first connection hole 20, a second connection hole 21 and a conjunction area 22 which communicates between the first and second connection holes 20, 21. The second connection hole 21 communicates with the space 12 by way of integrally forming as shown in FIGS. 1 to 8, or by way of inserting into the space 12. The first connection hole 20 is not covered by soil 85 so that the space 12 communicates with the outside of the pot unit 1. The way of the connection of the hollow tube 2 and the pot unit 1 can be the air blow molding as shown in FIGS. 1 to 7, or by way of plastic injection molding as shown in FIG. 9, or by way of connecting two individual parts by any known methods such as engagement and screwing.

When in manufacturing, hollow tube 2 is installed to the inner surface of a mold set 9 before pressurized air is introduced in the mold set 9 and before the mold set 9 is closed. A probe 95 is inserted into the mold set 9 and blows the melting plastic material P in the mold set 9 to expand the plastic material P to contact against the inner surface of the mold set 9 and to seal at least one end of the connection hole 21 of the hollow tube 2 such that the following two ways can be proceeded. The first way is that when the melting plastic material P is gradually solidified and cooled, the hollow tube 2 is integrally connected to the recessed reception area 13 by way of air blow molding. The conjunction area 22 of the hollow tube 2 then communicates with the space 12 of the pot unit 1 by way of drilling.

The second way is that, by continuously introducing air into the mold set 9 to generate pressure difference, the expanded plastic material P located outside of the connection hole 21 is forced and pushed into the connection hole 21 by air until the expanded plastic material P is extended and broken and is matched upon the connection hole 21 of the hollow tube 2. The plastic material P is solidified to form the pot unit 1 and the pot unit 1 is air-tightly connected to the hollow tube 2. The conjunction area 22 of the hollow tube 2 communicates with the space 12 in the pot unit 1. Therefore, the hollow tube 2 is integrally connected to the pot unit 1 in the space 12 and the reception area 13.

When planting a plant 80, the soil 85 is put in the reception area 13 and does not cover the first connection hole 20 of the path A to ensure that the space 12 communicates with outside of the pot unit 1. The liquid 83 such as water is poured into the water introducing unit 3 and the water is guided by the conjunction area 32 and stored in the space 12. When the level of the liquid 83 is higher than the through hole 133. The surface tension of the liquid 83 moves the liquid 83 upward by the siphonic effect and the liquid 83 is absorbed by the soil 85. The liquid is stopped pouring into the pot unit 1 until the space 12 is filled with the liquid 83. The seal unit 6 is used to seal the water introducing unit 3, an enclosed area is formed between the sealed water introducing area 3 sealed by the seal unit 6 and the through hole 133.

When the plant 80 uses the water in the soil 85, the pressure in the space 12 is smaller than the atmosphere so that the air outside of the pot unit 1 enters into the space 12 via the path A which is the hollow tube 2, the pressure pushes the level of the liquid 83 downward until the liquid 83 in the space 12 begins to move upward via the through hole 133 by the siphon effect to keep the soil 85 wet. Accordingly, the soil 85 in the reception area 13 maintains a certain level of humidity and the root of the plant is protected. The flow speed of the liquid 83 that 83 flows from the space 12 to the reception area 13 of the soil 85 can also be adjusted to keep the soil to be wet. Therefore, the owner of the plant 80 does not need to water the plant 80 while travelling.

While we have shown and described the embodiment in accordance with the present invention, it should be clear to those skilled in the art that further embodiments may be made without departing from the scope of the present invention.

What is claimed is:

1. A hollow pot comprising:
a pot unit having a space defined between an inner layer and an outer layer, an enclosed are defined in the space, the inner layer having a reception area, the outer layer supporting the inner layer, a through hole located in communication between the reception area and the space, a path communicating between the space and the outside of the pot unit, the inner layer of the space being air-tightly in contact with the outer layer, the path having a hollow tube which is connected between the space and the outside of the pot unit, the hollow tube having a first connection hole, a second connection hole and a conjunction area which communicates between the first and second connection holes, the second connection hole communicating with the space and the first connection hole being not covered by soil so that the space communicates with the outside of the pot unit.

2. The hollow pot as claimed in claim 1, wherein the inner and outer layers are two individual layers and are connected to each other, a seal member is located between the inner and outer layers.

3. The hollow pot as claimed in claim 1, wherein the inner and outer layers are integrally formed by air blow molding to make that the space be air-tight.

4. The hollow pot as claimed in claim 2, wherein the pot unit has a water introducing unit on an outside thereof and a seal unit seals the water introducing unit.

5. The hollow pot as claimed in claim 3, wherein the pot unit has a water introducing unit on an outside thereof and a seal unit seals the water introducing unit.

6. The hollow pot as claimed in claim 4, wherein the enclosed area is defined between the water introducing unit sealed by the seal unit and an inlet.

7. The hollow pot as claimed in claim 6, wherein the hollow tube is connected to the pot unit by way of air blow molding or injection molding or connection between two individual parts.

8. The hollow pot as claimed in claim 5, wherein the enclosed area is defined between the water introducing unit sealed by the seal unit and an inlet.

9. The hollow pot as claimed in claim 8, wherein the enclosed area is defined between the water introducing unit sealed by the seal unit and an inlet.

10. The hollow pot as claimed in claim 4, wherein the enclosed area is defined between the water introducing area sealed by the seal unit and the through hole.

11. The hollow pot as claimed in claim 10, wherein the hollow tube is connected to the pot unit by way of air blow molding or injection molding or connection between two individual parts.

12. The hollow pot as claimed in claim 5, wherein the enclosed area is defined between the water introducing area sealed by the seal unit and the through hole.

13. The hollow pot as claimed in claim 12, wherein the hollow tube is connected to the pot unit by way of air blow molding or injection molding or connection between two individual parts.

14. The hollow pot as claimed in claim 4, wherein the enclosed area is defined between the water introducing area sealed by the seal unit and a conjunction area of the hollow tube and the inner and outer layers of the pot unit.

15. The hollow pot as claimed in claim 14, wherein the hollow tube is connected to the pot unit by way of air blow molding or injection molding or connection between two individual parts.

16. The hollow pot as claimed in claim 5, wherein the enclosed area is defined between the water introducing area sealed by the seal unit and a conjunction area of the hollow tube and the inner and outer layers of the pot unit.

17. The hollow pot as claimed in claim 16, wherein the hollow tube is connected to the pot unit by way of air blow molding or injection molding or connection between two individual parts.
